(19) United States
(12) Patent Application Publication
(10) Pub. No.: US 2018/0254665 A1
(43) Pub. Date: Sep. 6, 2018

(54) POWER FEEDING DEVICE

(71) Applicants: Japan Agency for Marine-Earth Science and Technology, Yokosuka-shi (JP); Ryutech Corporation, Otsu-shi (JP)

(72) Inventors: Tomoya INOUE, Yokosuka-shi (JP); Junya ISHIWATA, Yokosuka-shi (JP); Ikuo AWAI, Otsu-shi (JP)

(73) Assignees: Japan Agency for Marine-Earth Science and Technology; Ryutech Corporation

(21) Appl. No.: 15/905,325

(22) Filed: Feb. 26, 2018

(30) Foreign Application Priority Data
Mar. 3, 2017 (JP) 2017-040772

(51) Int. Cl. H02J 50/10; E21B 17/00

(52) U.S. Cl. CPC H02J 50/10; H02J 7/025; E21B 17/003

(57) ABSTRACT

Provided is a power feeding device capable of performing wireless power feeding at a joint of elongated objects and mitigating a decline in transmission efficiency even through a long elongated object multistage-connected body. A power feeding device 1 includes an elongated object multistage-connected body in which elongated objects 3 each provided with a power feed circuit 30 are connected in multiple stages, wherein the power feed circuit 30 of one elongated object 3 is provided with a power-receiving coil 31 which wirelessly receives power from the power feed circuit 30 of another elongated object 3, a power feed line 32, and a power-transmitting coil 33 which wirelessly transmits power to the power feed circuit 30 of another elongated object 3, and the plurality of power feed circuits 30 constitute a periodic circuit.

### BACKGROUND OF THE INVENTION

### 1. Field of the Invention

The present invention relates to a power feeding device which feeds power through a long-elongated object multistage-connected body.

### 2. Description of the Related Art

When performing scientific seafloor drilling, numerous 10 m-long steel drill pipes are serially connected to create a long drill pipe multistage-connected body. Extension work of the drill pipe multistage-connected body is conducted on a seaborne research vessel. Mounting, for example, various sensors for sensing and cameras for photography for use in a drilling point or a geological stratum, to a tip of the drill pipe multistage-connected body or the like in association with drilling operations enables a great return to be gained from one drilling operation. However, it is extremely difficult to secure operating power for devices such as various measuring instruments to be mounted to the drill pipe multistage-connected body or the like.

A main cause of the difficulty in securing operating power for such devices is the significant distance between a power source and the devices. At a joint of drill pipes, structural issues prevent power cables from being connected by conventional methods. Therefore, a special method is required. For example, International Application Published under PCT No. WO2001/073331 (Japanese Translation of PCT Application No. 2003-531320) discloses a configuration in which a male screw and one electrical contact are formed at one end of a drill pipe, a female screw and another electrical contact are formed at another end of the drill pipe, and when two drill pipes are coupled using the male screw and the female screw, the one electrical contact and the other electrical contact come into contact with each other. In this case, in one drill pipe, the one electrical contact and the other electrical contact are connected to each other by a conductor.

### SUMMARY OF THE INVENTION

However, a joint of drill pipes when placed undersea is susceptible to movement due to water current and the like. Therefore, with a configuration structured as disclosed in International Application Published under PCT No. WO2001/073331, it is difficult to ensure that the one electrical contact and the other electrical contact come into contact with each other in a stable manner. In addition, electrical contacts readily corrode when in direct contact with sea water.

In light of such circumstances, the present inventors considered that wireless charging is desirably adopted at a joint of drill pipes and, through intensive research, devised a power feeding device capable of performing wireless power feeding at a joint of drill pipes and, at the same time, capable of mitigating a decline in transmission efficiency even through a long drill pipe multistage-connected body.

The present invention has been made in consideration of the reasons described above, and an object thereof is to provide a power feeding device capable of performing wireless power feeding at a joint of elongated objects such as drill pipes and mitigating a decline in transmission efficiency even through a long elongated object multistage-connected body such as a drill pipe multistage-connected body.

In order to achieve the object described above, a power feeding device according to a preferred embodiment of the present invention includes: a power transmitter provided with a power transmission circuit; an elongated object multistage-connected body in which elongated objects each provided with a power feed circuit are connected in multiple stages and that is connected to the power transmitter; and a load feeder which is provided with a load feed circuit, which is connected to the elongated object multistage-connected body, and which supplies power to a load, wherein the power transmission circuit is provided with: an AC power supply; a power transmission circuit line connected to the AC power supply; and a power transmission circuit coil connected to the power transmission circuit line, the power feed circuit is provided with: a power-receiving coil which is provided at one end of one elongated object and which wirelessly receives power from the power feed circuit of another elongated object on the one side connected to the one end of the one elongated object or the power transmission circuit; a power feed line of which one end is connected to the power-receiving coil; and a power-transmitting coil which is connected to another end of the power feed line, which is provided at another end of the one elongated object, and which wirelessly transmits power to the power feed circuit of another elongated object on the other side connected to the other end of the one elongated object or the load feed circuit, the load feed circuit is provided with: a load feed circuit coil; and a load feed circuit line connected to the load feed circuit coil, and the power-transmitting circuit coil and the power transmission circuit line of the power transmission circuit, a plurality of the power feed circuits, and the load feed circuit coil and the load feed circuit line of the load feed circuit constitute a periodic circuit.

Preferably, a control signal and/or a sensing signal is superimposed on AC power of the AC power supply.

Preferably, the power feed line is constituted by a first conductor and a second conductor which extend in an axial direction of the elongated object, and respective both ends of the power-receiving coil and the power-transmitting coil are connected to the first conductor and the second conductor.

Preferably, the power feed circuit is formed inside an elongated object main body made of metal.

Preferably, the power-receiving coil is enclosed by a first power-receiving coil enclosure sheet formed in a cylindrical shape and having higher conductivity than the elongated object main body, and the power-transmitting coil is enclosed by a first power-transmitting coil enclosure sheet formed in a cylindrical shape and having higher conductivity than the elongated object main body.

Preferably, the first power-receiving coil enclosure sheet and the first power-transmitting coil enclosure sheet are made of a copper-based metal or an aluminum-based metal.

Preferably, a second power-receiving coil enclosure sheet constituted by a cylindrical magnetic material is provided between the power-receiving coil and the first power-receiving coil enclosure sheet, and a second power-transmitting coil enclosure sheet constituted by a cylindrical magnetic material is provided between the power-transmitting coil and the first power-transmitting coil enclosure sheet.

Preferably, the second power-receiving coil enclosure sheet and the second power-transmitting coil enclosure sheet are made of ferrite.

Preferably, the power feed line is a shielded cable.

With the power feeding device according to the present invention, wireless power feeding (wireless power transmission and wireless power reception) can be performed at a joint of elongated objects such as drill pipes and a decline in transmission efficiency through a long elongated object multistage-connected body such as a drill pipe multistage-connected body can be mitigated.

### BRIEF DESCRIPTION OF THE DRAWINGS

FIG. 1 is a side view sectional diagram showing an outline of a power feeding device according to an embodiment of the present invention;

FIG. 2 is a circuit block diagram of a periodic circuit of the power feeding device described above;

FIG. 3 is a circuit block diagram of a unit cell of the periodic circuit of the power feeding device described above;

FIGS. 4A and 4B are sectional views showing an enlargement of a vicinity of a joint of elongated objects of the power feeding device described above, in which FIG. 4A represents a side view sectional diagram and FIG. 4B represents a plan view sectional diagram cut at a position of a line denoted by A-A in FIG. 4A;

FIG. 5 is a characteristic graph of a simulation result of the power feeding device described above;

FIG. 6 is an enlarged characteristic graph of the simulation result of the power feeding device described above; and

FIG. 7 is a characteristic graph of another simulation result of the power feeding device described above.

### DESCRIPTION OF THE PREFERRED EMBODIMENT

Hereinafter, an embodiment of the present invention will be described. A power feeding device 1 according to an embodiment of the present invention includes: a power transmitter 2 provided with a power transmission circuit 20; an elongated object multistage-connected body 3G in which elongated objects 3 each provided with a power feed circuit 30 are connected in multiple stages; and a load feeder 4 which is provided with a load feed circuit 40 and which supplies power to a load 5. Of the elongated object multistage-connected body 3G, one end 3Ga is connected to the power transmitter 2 and another end 3Gb is connected to the load feeder 4. For instance, in an example where the power feeding device 1 is used in scientific offshore drilling, the power transmitter 2 represents one of the devices installed on a research vessel, the elongated object 3 represents a drill pipe (the elongated object multistage-connected body 3G represents a drill pipe multistage-connected body), and the load feeder 4 supplies power to a device (the load) 5 such as various measuring instruments at a drilling point or a geological stratum. In this case, in addition to a drill pipe, the elongated object includes power-transmitting objects such as a pipe that is laid on the seabed or a drill rod or a boring pipe in the field of mining for example.

The power transmission circuit 20 is provided with: an AC power supply 21; a power transmission circuit line 22 connected to the AC power supply 21; and a power transmission circuit coil 23 connected to the power transmission circuit line 22. AC power of the AC power supply 21 has a frequency of, for example, 0.1 MHz to 10 MHz. In addition, a control signal and/or a sensing signal (data, commands or the like) for the device (the load) 5 such as various measuring instruments can also be superimposed on the AC power.

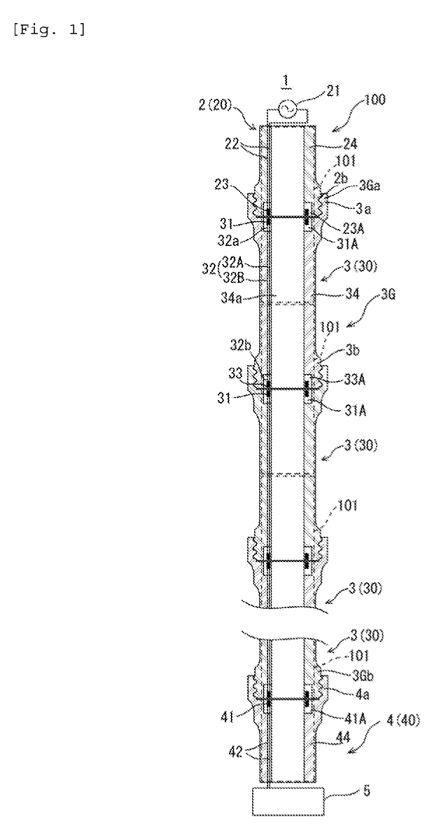

The power transmission circuit coil 23 normally shares a same configuration and a same shape as a power-transmitting coil 33 (to be described later) of the power feed circuit 30. In addition, the power transmission circuit coil 23 is provided at an end 2b connected to the elongated object 3 in the power transmitter 2. A vicinity of the end 2b normally shares a same configuration and a same shape as a vicinity of another end 3b (to be described later) of the elongated object 3, and includes a transmitter connected body 24 which corresponds to a shape of half (in FIG. 1, a lower half) of an elongated object main body 34 (to be described later). A screw (in the present embodiment, a male screw) can be formed on the transmitter connected body 24 for connection with the elongated object main body 34.

The power feed circuit 30 is provided with a power-receiving coil 31, a power feed line 32, and the power-transmitting coil 33.

The power-receiving coil 31 is provided at one end (an end on a side of the power transmitter 2) 3a of the elongated object 3. If the elongated object 3 is not for the one end 3Ga of the elongated object multistage-connected body 3G, another elongated object 3 of the one side is connected to the one end 3a of the elongated object 3. In this case, the power-receiving coil 31 wirelessly receives power from the power feed circuit 30 (more specifically, the power-transmitting coil 33) of the other elongated object 3 on the one side. In addition, if the elongated object 3 is for the one end 3Ga of the elongated object multistage-connected body 3G, the power transmitter 2 is connected to the one end 3a of the elongated object 3. In this case, the power-receiving coil 31 wirelessly receives power from the power transmission circuit 20 (more specifically, the power transmission circuit coil 23).

Of the power feed line 32, one end 32a is connected to the power-receiving coil 31 and another end 32b is connected to the power-transmitting coil 33. The power feed line 32 is generally constituted by a first conductor 32A and a second conductor 32B which extend in an axial direction of the elongated object 3, and respective both ends of the power-receiving coil 31 and the power-transmitting coil 33 are connected to the first conductor 32A and the second conductor 32B. In addition, when the elongated object 3 comes into contact with seawater such as when the elongated object 3 is used in scientific offshore drilling, the power feed line 32 is favorably a shielded cable such as a coaxial cable and the like to prevent the power feed line 32 from being affected by seawater. Furthermore, the power feed line 32 is normally fixed to the elongated object main body 34 (to be described later) by being formed and embedded in a groove in an axial direction of the elongated object main body 34.

The power-transmitting coil 33 is provided at the other end (an end on a side of the load 5) 3b of the elongated object 3. If the elongated object 3 is not for the other end 3Gb of the elongated object multistage-connected body 3G, the other elongated object 3 of the other side is connected to the other end 3b of the elongated object 3. In this case, the power-transmitting coil 33 wirelessly transmits power to the power feed circuit 30 (more specifically, the power-receiving coil 31) of the other elongated object 3 on the other side. In addition, if the elongated object 3 is for the other end 3Gb of the elongated object multistage-connected body 3G, the load feeder 4 is connected to the other end 3b of the elongated object 3. In this case, the power-transmitting coil 33 wirelessly transmits power to the load feed circuit 40 (more specifically, a load feed circuit coil 41).

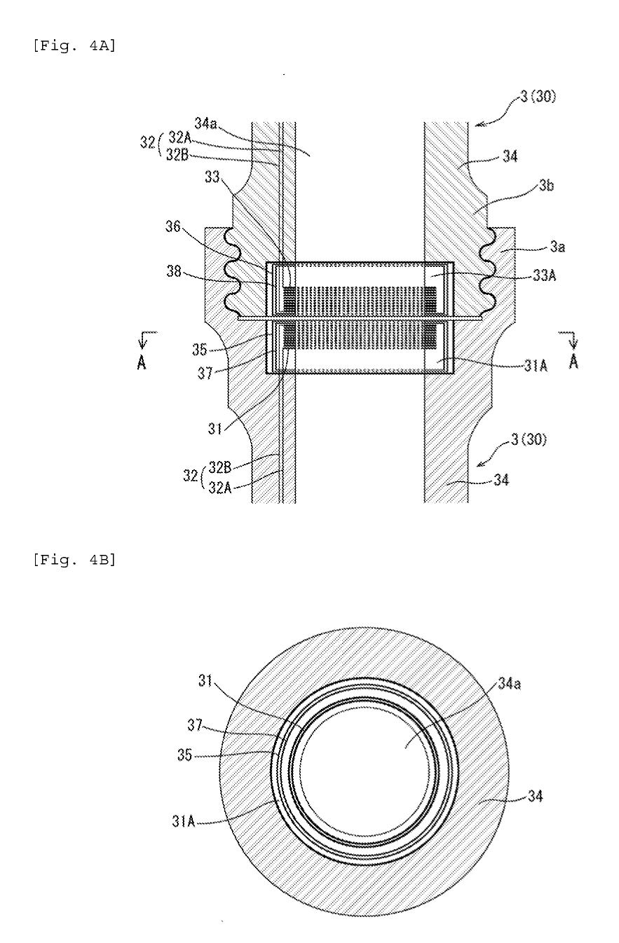

The elongated object 3 has the elongated object main body 34 and, in many cases such as when used in scientific offshore drilling, the elongated object 3 is made of metal. The power feed circuit 30 is formed inside the elongated object main body 34 in many cases. At the one end 3a of the elongated object 3, a screw (in the present embodiment, a female screw) can be formed on the elongated object main body 34 for connection with another elongated object main body 34 (or transmitter connected body 24). At the other end 3b of the elongated object 3, a screw (in the present embodiment, a male screw) can be formed on the elongated object main body 34 for connection with another elongated object main body 34 (or load feeder connected body 44 to be described later). Furthermore, in many cases such as when used in scientific offshore drilling, the elongated object main body 34 has a pipe shape or a tube shape as shown in FIG. 1 (as well as FIGS. 4A and 4B to be described later), and includes a hollow section 34a. Seawater and the like flow through the hollow section 34a. Moreover, the power-receiving coil 31 and the power-transmitting coil 33 are wound around the hollow section 34a. In addition, the transmitter connected body 24 and the load feeder connected body 44 have structures similar to that of the elongated object main body 34, and the power transmission circuit coil 23 and the load feed circuit coil 41 (to be described later) are wound around a hollow section similar to the hollow section 34a.

Moreover, the power-receiving coil 31 can be made into a single power-receiving body unit 31A by enclosing the power-receiving coil 31 with an insulator. In addition, the power-transmitting coil 33 can also be made into a single power-transmitting body unit 33A by enclosing the power-transmitting coil 33 with an insulator. Furthermore, the power-receiving body unit 31A and the power-transmitting body unit 33A can be connected by the power feed line 32, and waterproofing and the like can be applied thereto to unitize the connected body units as a whole. In addition, the power transmission circuit coil 23 and the load feed circuit coil 41 can be similarly made into a single power-transmitting body unit 23A and a single power-receiving body unit 41A.

The load feed circuit 40 is provided with the load feed circuit coil 41 and a load feed circuit line 42 that is connected to the load feed circuit coil 41. The load feed circuit line 42 is connected to the load 5.

The load feed circuit coil 41 normally shares a same configuration and a same shape as the power-receiving coil 31 of the power feed circuit 30. In addition, the load feed circuit coil 41 is provided at an end 4a connected to the elongated object 3 in the load feeder 4. A vicinity of the end 4a normally shares a same configuration and a same shape as a vicinity of the one end 3a of the elongated object 3, and includes a load feeder connected body 44 which corresponds to a shape of half (in FIG. 1, an upper half) of the elongated object main body 34. A screw (in the present embodiment, a female screw) can be formed on the load feeder connected body 44 for connection with the elongated object main body 34.

The power transmission circuit coil 23 and the power transmission circuit line 22 of the power transmission circuit 20, a plurality of the power feed circuits 30, and the load feed circuit coil 41 and the load feed circuit line 42 of the load feed circuit 40 described above can constitute a periodic circuit 100. As shown in FIG. 2, the periodic circuit 100 is configured such that unit cells 101 constituting one period of the periodic circuit 100 are connected in multiple stages. A length d of one period of the periodic circuit 100 is substantially equal to a pitch between the elongated objects 3 when constructing the elongated object multistage-connected body 3G. The unit cell 101 can also be regarded as a division in the periodic circuit 100 being shifted by a half period from the power feed circuit 30 (refer to the unit cells 101 depicted by dashed lines in FIG. 1).

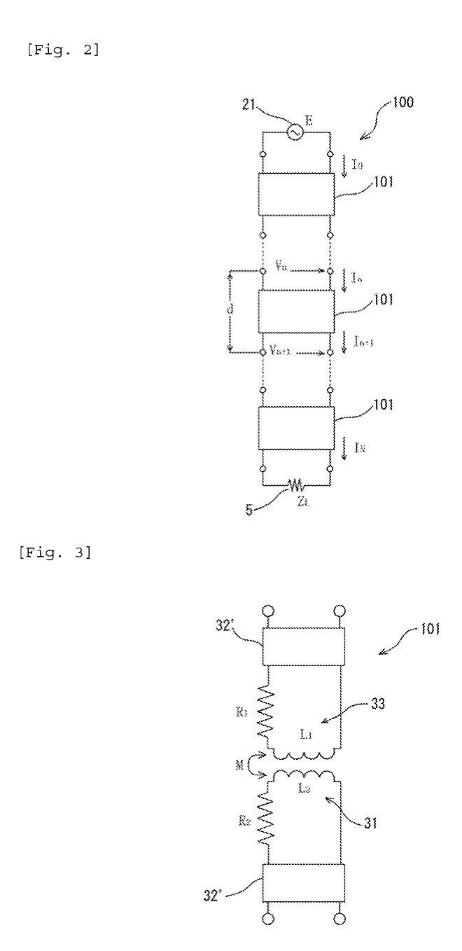

As shown in FIG. 3, in the unit cell 101, the power-receiving coil 31 and the power-transmitting coil 33 are arranged with a joint of the elongated objects 3 at center, and a half power feed line 32′ is arranged on the each outside thereof. In FIG. 3, L₁ and R₁ respectively denote an inductive component and a resistive component of the power-transmitting coil 33, L₂ and R₂ respectively denote an inductive component and a resistive component of the power-receiving coil 31, and M denotes mutual inductance. Moreover, the same unit cell 101 is also applied with a joint of the power transmitter 2 and the elongated object 3 at center and with a joint of the elongated object 3 and the load feeder 4 at center. In this case, the power transmission circuit line 22 and the load feed circuit line 42 can be respectively regarded as substantially the same as the half power feed line 32′.

Constructing the periodic circuit 100 and optimizing the periodic circuit 100 by an analysis method and a simulation (to be described later) enables the power feeding device 1 to perform wireless power feeding (wireless power transmission and wireless power reception) at a joint of the elongated objects 3 and enables a decline in transmission efficiency through the long elongated object multistage-connected body 3G to be mitigated.

Details of peripheral structures of the power-receiving coil 31 and the power-transmitting coil 33 of the power feeding device 1 will now be described below with reference to FIGS. 4A and 4B. Moreover, in FIG. 4A, lines hidden behind the hollow section 34a of the elongated object main body 34 are depicted by dashed lines. In addition, the first conductor 32A and the second conductor 32B are schematically drawn in FIG. 4A but are omitted in FIG. 4B.

The power-receiving coil 31 in the power feed circuit 30 can be configured to be enclosed by a cylindrical first power-receiving coil enclosure sheet 35, and the power-transmitting coil 33 in the power feed circuit 30 can be configured to be enclosed by a cylindrical first power-transmitting coil enclosure sheet 36. Conductivity of the first power-receiving coil enclosure sheet 35 and conductivity of the first power-transmitting coil enclosure sheet 36 (for example, made of a copper-based metal or an aluminum-based metal) are both higher than that of the elongated object main body 34. Although the elongated object main body 34 made of metal is normally made of an iron-based metal and a loss occurs due to a flowing current when affected by magnetism of the power-receiving coil 31 and the power-transmitting coil 33, the first power-receiving coil enclosure sheet 35 and the first power-transmitting coil enclosure sheet 36 are capable of suppressing loss caused by the elongated object main body 34.

In addition, a cylindrical second power-receiving coil enclosure sheet 37 can be provided between the power-receiving coil 31 and the first power-receiving coil enclosure sheet 35, and a cylindrical second power-transmitting coil enclosure sheet 38 can be provided between the power-transmitting coil 33 and the first power-transmitting coil enclosure sheet 36. The second power-receiving coil enclosure sheet 37 and the second power-transmitting coil enclosure sheet 38 are both magnetic bodies (for example, made of ferrite). The second power-receiving coil enclosure sheet 37 and the second power-transmitting coil enclosure sheet 38 are capable of mitigating fluctuations in characteristics caused by providing the first power-receiving coil enclosure sheet 35 and the first power-transmitting coil enclosure sheet 36.

Moreover, the power-receiving coil 31, the first power-receiving coil enclosure sheet 35, and the second power-receiving coil enclosure sheet 37 can be arranged via an insulator and included in the single power-receiving body unit 31A described earlier. The power-transmitting coil 33, the first power-transmitting coil enclosure sheet 36, and the second power-transmitting coil enclosure sheet 38 can be arranged via an insulator and included in the single power-transmitting body unit 33A described earlier. In addition, the power transmission circuit coil 23 can also be provided with components similar to the first power-transmitting coil enclosure sheet 36 and the second power-transmitting coil enclosure sheet 38, and the components can be included in the single power-transmitting body unit 23A. The load feed circuit coil 41 can also be provided with components similar to the first power-receiving coil enclosure sheet 35 and the second power-receiving coil enclosure sheet 37, and the components can be included in the single power-receiving body unit 41A.

Next, a basic analysis method of the periodic circuit 100 will be described. First, a method of obtaining a propagation constant γ of the periodic circuit 100 will be described, followed by a description of a method of obtaining the Bloch impedance of the periodic circuit 100 and then by a description of a method of obtaining transmission efficiency η of the periodic circuit 100.

In the unit cell 101 shown in FIG. 3, a Z-matrix representing a relationship between input and output when excluding the half power feed line 32′ is generally given by expression (1) below.

$$\begin{matrix}[ Math . 1 ] & \\ [ Z ] = [ \begin{matrix}{Z}_{11} & {Z}_{12} \\ {Z}_{21} & {Z}_{22}\end{matrix} ] = [ \begin{matrix}{R}_{1} + j ω {L}_{1} & j ω M \\ j ω M & {R}_{2} + j ω {L}_{2}\end{matrix} ] & ( 1 )\end{matrix}$$

Since the unit cell 101 is symmetrical with respect to a discontinuous section (a joint), we can assume that R₁=R₂=R and L₁=L₂=L, and since the periodic circuit 100 is a circuit to be connected in cascade, the Z-matrix represented by expression (1) can be simplified and transformed into an F-matrix (ABCD-matrix) given by expression (2) below that allows a cascaded circuit to be calculated with greater ease.

$$\begin{matrix} [ Math . 2 ] & \\ [ \overline{F} ] = [ \begin{matrix}\overline{A} & \overline{B} \\ \overline{C} & \overline{D}\end{matrix} ] = [ \begin{matrix}\frac{L}{M} - j \frac{R}{ω M} & ( \frac{2 RL}{M} - j \{ \frac{{R}^{2}}{ω M} + ω M - \frac{ω {L}^{2}}{M} \} ) \\ \frac{1}{j ω {MY}_{0}} & \frac{L}{M} - j \frac{{R}^{2}}{ω M}\end{matrix} ] & ( 2 )\end{matrix}$$

Here, horizontal bars added above the respective components A, B, C, and D signify that the components have been normalized by characteristic admittance Y₀ of the power feed line 32. The relation of characteristic admittance Y₀ and characteristic impedance Z₀ is Y₀=1/Z₀. Since an F-matrix (ABCD-matrix) corresponding to one period is to be calculated on this basis, expression (3) is derived when assuming that the half power feed line 32′ is connected to both sides of the discontinuous section shown in FIG. 3.

$$\begin{matrix} [ Math . 3 ] & \\ [ \begin{matrix}\overline{A} & \overline{B} \\ \overline{C} & \overline{D}\end{matrix} ] = [ \begin{matrix}\begin{matrix}\frac{L}{M} cos θ + \frac{1}{2} {x}_{1}^{′} sin θ + \\ j \{ \frac{RL}{{MZ}_{s}} sin θ - \frac{R}{ω M} cos θ \}\end{matrix} & \begin{matrix}\frac{R}{M} \{ \frac{1}{ω} sin θ + \frac{L}{{Z}_{0}} ( cos θ + 1 ) \} + \\ j \{ - \frac{1}{2} {x}_{1}^{′} cos θ + \frac{L}{M} sin θ + \frac{1}{2} {x}_{2}^{′} \}\end{matrix} \\ \begin{matrix}\frac{R}{M} \{ \frac{1}{ω} sin θ + \frac{L}{{Z}_{0}} ( cos θ + 1 ) \} + \\ j \{ - \frac{1}{2} {x}_{1}^{′} cos θ + \frac{L}{M} sin θ - \frac{1}{2} {x}_{2}^{′} \}\end{matrix} & \begin{matrix}\frac{L}{M} cos θ + \frac{1}{2} {x}_{1}^{′} sin θ + \\ j \{ \frac{RL}{{MZ}_{0}} sin θ - \frac{R}{ω M} cos θ \}\end{matrix}\end{matrix} ] & ( 3 )\end{matrix}$$

Here, θ denotes a phase shift amount, and θ=k₀d (where k₀ denotes a propagation constant of the power feed line 32 and d denotes a length of one period described earlier). x′₁ and x′₂ are as given by expression (4).

$$\begin{matrix}[ Math . 4 ] & \\ {x}_{1}^{′} = \frac{1}{ω {MY}_{0}} + ( \frac{{R}^{2}}{ω M} - \frac{ω ( {L}^{2} - {M}^{2} )}{M} ) {Y}_{0} \\ {x}_{2}^{′} = \frac{1}{ω {MY}_{0}} - ( \frac{{R}^{2}}{ω M} - \frac{ω ( {L}^{2} - {M}^{2} )}{M} ) {Y}_{0} & ( 4 )\end{matrix}$$

Expression (5) below is true between input of a single unit cell 101ₙ and input of a subsequent-stage unit cell 101ₙ₊₁ (output of the unit cell 101ₙ).

$$\begin{matrix}[ Math . 5 ] & \\ [ \begin{matrix}{V}_{n} \\ {I}_{n}\end{matrix} ] = [ \begin{matrix}\overline{A} & \overline{B} \\ \overline{C} & \overline{D}\end{matrix} ] [ \begin{matrix}{V}_{n + 1} \\ {I}_{n + 1}\end{matrix} ] & ( 5 )\end{matrix}$$

In this case, expression (6) must be true for a propagation solution to exist.

$$\begin{matrix}[ Math . 6 ] & \\ [ \begin{matrix}{V}_{n} \\ {I}_{n}\end{matrix} ] = [ \begin{matrix}{e}^{γ d} & 0 \\ 0 & {e}^{γ d}\end{matrix} ] [ \begin{matrix}{V}_{n + 1} \\ {I}_{n + 1}\end{matrix} ] & ( 6 )\end{matrix}$$

γ denotes a propagation constant in a broad sense, and d denotes a length of one period described earlier. Substituting expression (6) into expression (4) derives expression (7) below.

$$\begin{matrix}[ Math . 7 ] & \\ [ \begin{matrix}\overline{A} - {e}^{γ d} & \overline{B} \\ \overline{C} & \overline{D} - {e}^{γ d}\end{matrix} ] [ \begin{matrix}{V}_{n + 1} \\ {I}_{n + 1}\end{matrix} ] = 0 & ( 7 )\end{matrix}$$

In order for expression (7) to have a solution, since a coefficient determinant must be set to 0, expression (8) below is derived.

$$\begin{matrix}[ Math . 8 ] & \\ \vert \begin{matrix}\overline{A} - {e}^{γ d} & \overline{B} \\ \overline{C} & \overline{D} - {e}^{γ d}\end{matrix} \vert = \overline{A} \overline{D} - \overline{B} \overline{C} + {e}^{2 γ d} - {e}^{γ d} ( \overline{A} + \overline{D} ) = 0 & ( 8 )\end{matrix}$$

Substituting a reciprocal condition given by expression (8′) below and respective components of expression (3) derives expression (9) below.

$$\begin{matrix} [ Math . 9 ] & \\ \overline{A} \overline{D} - \overline{B} \overline{C} = 1 & ( {8}^{′} ) \\ cosh γ d = \frac{\overline{A} + \overline{D}}{2} = \frac{L}{M} cos θ + \frac{1}{2} {x}_{1}^{′} sin θ + j \{ \frac{RL}{{MZ}_{0}} sin θ - \frac{R}{ω M} cos θ \} & ( 9 )\end{matrix}$$

Here, expanding expression (9) on the assumption that γ=α+jβ derives expression (10) below.

[Math. 10]

cos γd=cos h(α+jβ)d=cos hαd cos βd+j sin hαd sin βd (10)

Furthermore, dividing expression (9) into a real part and an imaginary part using α<<β derives expressions (11) and (12) below.

$$\begin{matrix} [ Math . 11 ] & \\ α d = {sinh}^{- 1} ( \frac{ω LR sin {k}_{0} d - {RZ}_{0} cos {k}_{0} d}{ω {MZ}_{0} sin β d} ) & ( 11 ) \\ [ Math . 12 ] & \\ β d = {cos}^{- 1} [ \frac{L}{M} cos {k}_{0} d + \frac{1}{2} \{ \frac{{Z}_{0}}{ω M} + ( \frac{{R}^{2}}{ω M} - \frac{ω ( {L}^{2} - {M}^{2} )}{M} ) \frac{1}{{Z}_{0}} \} sin {k}_{0} d ] & ( 12 )\end{matrix}$$

In this manner, α and β can be expressed independently. Note that expressions (11) and (12) have been normalized by the length d of one period.

Next, the Bloch impedance that is characteristic impedance of a periodic circuit will be obtained.

The Bloch impedance is obtained by calculating a voltage/current ratio as represented by expression (13) below from expression (7).

$$\begin{matrix}[ Math . 13 ] & \\ {\overline{Z}}_{B} = \frac{{Z}_{B}}{{Z}_{0}} = \frac{{V}_{n + 1}}{{I}_{n + 1}} = \frac{- \overline{B}}{\overline{A} - {e}^{γ d}} = \frac{\overline{D} - {e}^{γ d}}{\overline{C}} & ( 13 )\end{matrix}$$

From expression (13), γd is obtained as represented by expression (14) below.

$$\begin{matrix}[ Math . 14 ] & \\ {e}^{γ d} = \frac{\overline{A} + \overline{D} \pm \sqrt{{( \overline{A} + \overline{D} )}^{2} - 4}}{2} & ( 14 )\end{matrix}$$

Substituting expression (14) into expression (13) derives expression (15) below.

$$\begin{matrix}[ Math . 15 ] & \\ {\overline{Z}}_{B}^{\pm } = \frac{( 2 \overline{B} )}{( \overline{D} - \overline{A} \pm \sqrt{{( \overline{A} + \overline{D} )}^{2} - 4} )} & ( 15 )\end{matrix}$$

The Bloch impedance represented by expression (15) is the characteristic impedance of a wave that propagates in a +/−direction. Since the periodic circuit 100 can be considered symmetrical, expression (15′) is true, and the Bloch impedance is simplified as represented by expression (16) below based on the reciprocity represented by expression (8′).

$$\begin{matrix}[ Math . 16 ] & \\ \overline{A} = \overline{D} & ( {15}^{′} ) \\ {\overline{Z}}_{B}^{\pm } = \sqrt{\frac{\overline{B}}{\overline{C}}} & ( 16 )\end{matrix}$$

The Bloch impedance is simplified as represented by expression (16), and the value calculated by expression (3) need only be substituted into expression (16).

Next, transmission efficiency η of the periodic circuit 100 is obtained.

Voltage and current at an input-side nodal point of a unit cell 101n is represented by expression (17) below. Note that A and B in expression (17) differ from A and B used thus far. In this case, A and B are used because amplitudes of an incident wave and a reflected wave are customarily denoted by symbols A and B.

$$\begin{matrix}[ Math . 17 ] & \\ {V}_{n} = A {e}^{- γ nd} + {Be}^{γ nd} \\ {I}_{n} = \frac{A}{{Z}_{B}} {e}^{- γ nd} - \frac{B}{{Z}_{B}} {e}^{γ nd} & ( 17 )\end{matrix}$$

γ and Z_{B} in expression (17) are, respectively, a propagation constant and the Bloch impedance obtained as described above. By respectively substituting n=0 and N=100 into expression (17) at a start terminal and an end terminal of the periodic circuit 100, a voltage V₀ and a current I₀ at the start terminal and a voltage V_{N} and a current I_{N} at the end terminal are obtained as represented by expressions (18) and (18′). Furthermore, since a voltage source E is connected to the start terminal and a load impedance Z_{L} is connected to the end terminal, (18″) is true.

$$\begin{matrix}[ Math . 18 ] & \\ {V}_{0} = A + B \\ {I}_{0} = \frac{A}{{Z}_{B}} - \frac{B}{{Z}_{B}} & ( 18 ) \\ {V}_{N} = {Ae}^{- γ Nd} + {Be}^{γ Nd} \\ {I}_{N} = \frac{A}{{Z}_{B}} {e}^{- γ Nd} - \frac{B}{{Z}_{B}} {e}^{γ Nd} & ( {18}^{′} ) \\ {V}_{0} = E \\ {V}_{N} = {Z}_{L} {I}_{N} & ( {18}^{″} )\end{matrix}$$

Erasing V₀, V_{N}, I₀, and I_{N} therefrom derives expression (19) below.

$$\begin{matrix}[ Math . 19 ] & \\ A = \frac{( {Z}_{L} + {Z}_{B} ) {e}^{γ Nd}}{( {Z}_{L} + {Z}_{B} ) {e}^{γ Nd} + ( {Z}_{L} - {Z}_{B} ) {e}^{- γ Nd}} E \\ B = \frac{( {Z}_{L} - {Z}_{B} ) {e}^{- γ Nd}}{( {Z}_{L} + {Z}_{B} ) {e}^{γ Nd} + ( {Z}_{L} - {Z}_{B} ) {e}^{- γ Nd}} E & ( 19 )\end{matrix}$$

Subsequently, by substituting expression (19) into expression (17), voltage and current at each node point are obtained as represented by expression (20) below.

$$\begin{matrix}[ Math . 20 ] & \\ {V}_{n} = \frac{{Z}_{L} cosh ( N - n ) γ d + {Z}_{B} sinh ( N - n ) γ d}{{Z}_{L} cosh N γ d + {Z}_{B} sinh N γ d} E \\ {I}_{n} = \frac{{Z}_{L} cosh ( N - n ) γ d + {Z}_{B} sinh ( N - n ) γ d}{{Z}_{L} cosh N γ d + {Z}_{B} sinh N γ d} \frac{E}{{Z}_{B}} & ( 20 )\end{matrix}$$

Impedance toward a load side from any node point n is given by dividing Vₙ by Iₙ as expression (21) below.

$$\begin{matrix}[ Math . 21 ] & \\ {Z}_{n} = {Z}_{B} \frac{{Z}_{L} + {Z}_{B} tanh ( N - n ) γ d}{{Z}_{B} + {Z}_{L} tanh ( N - n ) γ d} & ( 21 )\end{matrix}$$

In addition, transmission efficiency η is given using expression (20) by expression (22) below.

$$\begin{matrix}[ Math . 22 ] & \\ \begin{matrix}η = \frac{Re [ {V}_{N} {Γ}_{N} ]}{Re [ {V}_{0} {Γ}_{0} ]} \\ = \frac{Re [ {Z}_{L} {Z}_{B}^{′} ]}{Re [ \begin{matrix}\{ {Z}_{L} cosh ( N γ d ) + {Z}_{B} sinh ( N γ d ) \} \\ {\{ {Z}_{L} sinh ( N γ d ) + {Z}_{B} cosh ( N γ d ) \}}^{′}\end{matrix} ]}\end{matrix} & ( 22 )\end{matrix}$$

Next, a result of a simulation performed using an electromagnetic field simulator will be described.

The elongated object main body 34 was constructed as a steel pipe with relative permittivity of 1, relative permeability of 4000, and conductivity of 1.03e7 [S/m], and had a length of 10 m, an outer diameter of 135 mm, an inner diameter of 114 mm, and a thickness of 10.6 mm. The power transmission circuit coil 23, the power-receiving coil 31, the power-transmitting coil 33, and the load feed circuit coil 41 were all double-wound with an outer coil diameter of 87.2 mm, an inner coil diameter of 83.2 mm, and a gap between outer and inner coils of 2 mm, and the outer and inner coils respectively had a pitch of 1.5 mm and 10 number of turns. The first power-receiving coil enclosure sheet 35 and the first power-transmitting coil enclosure sheet 36 were made of copper with relative permittivity of 1, relative permeability of 0.999991, and conductivity of 58e6 [S/m], and had an outer diameter of 110 mm, an inner diameter of 109.4 mm, and a thickness of 0.3 mm. The second power-receiving coil enclosure sheet 37 and the second power-transmitting coil enclosure sheet 38 were ferrite sheets with relative permittivity of 15, relative permeability of 500, conductivity of 0.01 [S/m], and tan δ of 0.5, and had an outer diameter of 108.8 mm, an inner diameter of 108.2 mm, and a thickness of 0.3 mm. Seawater had relative permittivity of 81, relative permeability of 0.99991, conductivity of 4 [S/m], and a diameter of 76.22 mm. 100 elongated objects 3 were serially connected to create the elongated object multistage-connected body 3G with a total length of 1 km.

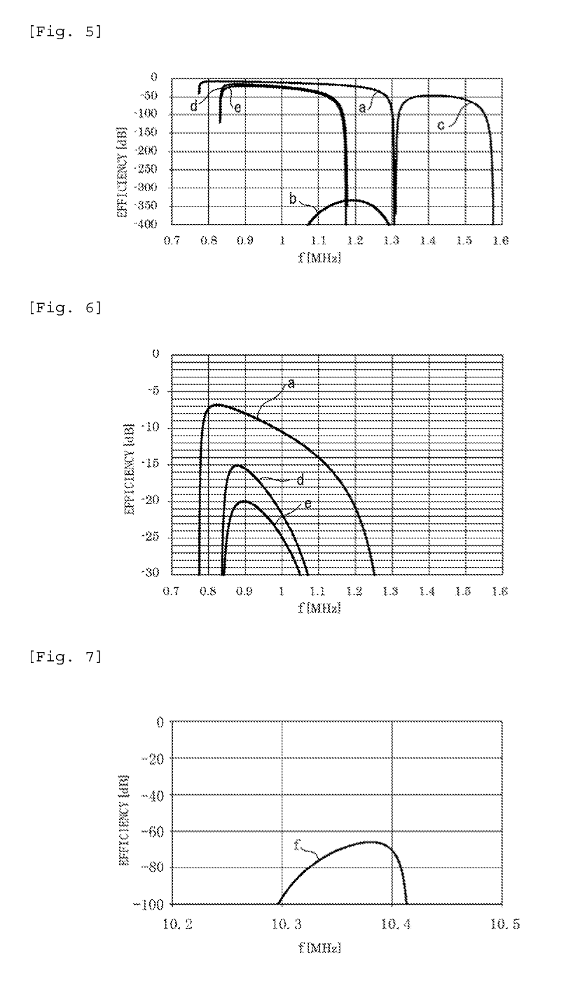

FIG. 5 shows a simulation result of transmission efficiency η. In addition, FIG. 6 shows the simulation result of transmission efficiency η in which a vertical axis has been expanded to −30 dB to 0 dB. In the diagrams, a curved line a represents an airborne state (excluding the elongated object main body 34, the first power-receiving coil enclosure sheet 35, the first power-transmitting coil enclosure sheet 36, the second power-receiving coil enclosure sheet 37, and the second power-transmitting coil enclosure sheet 38) having maximum transmission efficiency η of −7 dB. In the diagrams, a curved line b represents a state where the elongated object main body 34 has been added to the condition represented by the curved line a and which has maximum transmission efficiency η of −330 dB. In the diagrams, a curved line c represents a state where the first power-receiving coil enclosure sheet 35 and the first power-transmitting coil enclosure sheet 36 have been added to the condition represented by the curved line b and which has maximum transmission efficiency η of −50 dB. In the diagrams, a curved line d represents a state where the second power-receiving coil enclosure sheet 37 and the second power-transmitting coil enclosure sheet 38 have been added to the condition represented by the curved line c and which has maximum transmission efficiency η of −15 dB. In the diagrams, a curved line e represents a state where seawater has been added to the condition represented by the curved line d and which has maximum transmission efficiency η of −20 dB.

A comparison between the curved line a and the curved line b reveals that the presence of the elongated object main body 34 causes transmission efficiency to rapidly decline. A comparison between the curved line b and the curved line c reveals that, even when the elongated object main body 34 is present, adding the first power-receiving coil enclosure sheet 35 and the first power-transmitting coil enclosure sheet 36 mitigates a decline in transmission efficiency. A comparison between the curved line b and the curved line d reveals that, even when the elongated object main body 34 is present, adding the second power-receiving coil enclosure sheet 37 and the second power-transmitting coil enclosure sheet 38 in addition to the first power-receiving coil enclosure sheet 35 and the first power-transmitting coil enclosure sheet 36 further mitigates a decline in transmission efficiency. A comparison between the curved line d and the curved line e reveals that, even when both the elongated object main body 34 and seawater are present, adding the second power-receiving coil enclosure sheet 37 and the second power-transmitting coil enclosure sheet 38 in addition to the first power-receiving coil enclosure sheet 35 and the first power-transmitting coil enclosure sheet 36 enables a decline in transmission efficiency η to be mitigated. Constructing the periodic circuit 100 and optimizing the periodic circuit 100 by an analysis method and a simulation as described above enables the power feeding device 1 to mitigate a decline in transmission efficiency η.

Next, a simulation for demonstrating that a control signal and/or a sensing signal (data, commands or the like) can be superimposed on the AC power will be described.

The elongated object main body 34 was the same as that used in the simulation described above. The power transmission circuit coil 23, the power-receiving coil 31, the power-transmitting coil 33, and the load feed circuit coil 41 were all double-wound in the same pitch and the same number of windings as in the simulation described above, and had an outer coil diameter of 108.6 mm and an inner coil diameter of 102.6 mm.

The first power-receiving coil enclosure sheet 35 and the first power-transmitting coil enclosure sheet 36 were made of copper with the same relative permittivity, relative permeability, and conductivity as in the simulation described above, and had a thickness of 0.1 mm. The second power-receiving coil enclosure sheet 37 and the second power-transmitting coil enclosure sheet 38 were ferrite sheets with relative permittivity of 1, relative permeability of 130, and tan δ of 0.01, and had a thickness of 0.1 mm. Seawater had the same relative permittivity, relative permeability, and conductivity as in the simulation described above. The number of elongated objects 3 in the elongated object multistage-connected body 3G was the same as in the simulation described above. Most of the conditions were kept the same as in the simulation described above in this manner to enable simulation results to be compared with each other.

FIG. 7 shows a simulation result of transmission efficiency η. In the diagram, a curved line f represents a state including all of the elongated object main body 34, the power transmission circuit coil 23, the power-receiving coil 31, the power-transmitting coil 33, the load feeder circuit coil 41, the first power-receiving coil enclosure sheet 35, the first power-transmitting coil enclosure sheet 36, the second power-receiving coil enclosure sheet 37, and the second power-transmitting coil enclosure sheet 38, the curved line f having maximum transmission efficiency η of −66 dB at a frequency of 10.38 MHz. This indicates that, by setting a frequency of a control signal and/or a sensing signal to a vicinity of 10.38 MHz and setting a frequency of AC power to a vicinity of 1 MHz based on the simulation result described above, the control signal and/or the sensing signal can be superimposed on AC power. Moreover, the frequency of the control signal and/or the sensing signal is not limited to the vicinity of 10.38 MHz and may be set to another frequency (for example, a frequency between 5 MHz and 6 MHz or a frequency equal to or higher than 20 MHz) as long as transmission efficiency η of a certain level can be obtained.

While a power feeding device according to an embodiment of the present invention has been described above, it is to be understood that the present invention is not limited to the embodiment described above and various design modifications may be made without departing from the matters described in the scope of claims. For example, while the embodiment described above enables the power feeding device 1 to mitigate a decline in transmission efficiency η by adding the first power-receiving coil enclosure sheet 35 and the first power-transmitting coil enclosure sheet 36 as well as the second power-receiving coil enclosure sheet 37 and the second power-transmitting coil enclosure sheet 38, the periodic circuit 100 can also be optimized by further modifying dimensions or constants, by other additional means, or the like based on the analysis method and the simulation described above.

What is claimed is:

1. A power feeding device, comprising:
a power transmitter provided with a power transmission circuit;
an elongated object multistage-connected body in which elongated objects each provided with a power feed circuit are connected in multiple stages and that is connected to the power transmitter; and
a load feeder which is provided with a load feed circuit, which is connected to the elongated object multistage-connected body, and which supplies power to a load, wherein
the power transmission circuit is provided with: an AC power supply; a power transmission circuit line connected to the AC power supply; and a power transmission circuit coil connected to the power transmission circuit line,
the power feed circuit is provided with: a power-receiving coil which is provided at one end of one elongated object and which wirelessly receives power from the power feed circuit of another elongated object on the one side connected to the one end of the one elongated object or the power transmission circuit; a power feed line of which one end is connected to the power-receiving coil; and a power-transmitting coil which is connected to another end of the power feed line, which is provided at another end of the one elongated object, and which wirelessly transmits power to the power feed circuit of another elongated object on the other side connected to the other end of the one elongated object or the load feed circuit,
the load feed circuit is provided with: a load feed circuit coil; and a load feed circuit line connected to the load feed circuit coil, and
the power-transmitting circuit coil and the power transmission circuit line of the power transmission circuit, a plurality of the power feed circuits, and the load feed circuit coil and the load feed circuit line of the load feed circuit constitute a periodic circuit.

2. The power feeding device according to claim 1, wherein
a control signal and/or a sensing signal is superimposed on AC power of the AC power supply.

3. The power feeding device according to claim 1, wherein
the power feed line is constituted by a first conductor and a second conductor which extend in an axial direction of the elongated object, and respective both ends of the power-receiving coil and the power-transmitting coil are connected to the first conductor and the second conductor.

4. The power feeding device according to claim 2, wherein
the power feed line is constituted by a first conductor and a second conductor which extend in an axial direction of the elongated object, and respective both ends of the power-receiving coil and the power-transmitting coil are connected to the first conductor and the second conductor.

5. The power feeding device according to claim 1, wherein
the power feed circuit is formed inside an elongated object main body made of metal.

6. The power feeding device according to claim 2, wherein
the power feed circuit is formed inside an elongated object main body made of metal.

7. The power feeding device according to claim 3, wherein
the power feed circuit is formed inside an elongated object main body made of metal.

8. The power feeding device according to claim 4, wherein
the power feed circuit is formed inside an elongated object main body made of metal.

9. The power feeding device according to claim 5, wherein
the power-receiving coil is enclosed by a first power-receiving coil enclosure sheet formed in a cylindrical shape and having higher conductivity than the elongated object main body, and
the power-transmitting coil is enclosed by a first power-transmitting coil enclosure sheet formed in a cylindrical shape and having higher conductivity than the elongated object main body.

10. The power feeding device according to claim 6, wherein
the power-receiving coil is enclosed by a first power-receiving coil enclosure sheet formed in a cylindrical shape and having higher conductivity than the elongated object main body, and
the power-transmitting coil is enclosed by a first power-transmitting coil enclosure sheet formed in a cylindrical shape and having higher conductivity than the elongated object main body.

11. The power feeding device according to claim 7, wherein
the power-receiving coil is enclosed by a first power-receiving coil enclosure sheet formed in a cylindrical shape and having higher conductivity than the elongated object main body, and
the power-transmitting coil is enclosed by a first power-transmitting coil enclosure sheet formed in a cylindrical shape and having higher conductivity than the elongated object main body.

12. The power feeding device according to claim 8, wherein
the power-receiving coil is enclosed by a first power-receiving coil enclosure sheet formed in a cylindrical shape and having higher conductivity than the elongated object main body, and
the power-transmitting coil is enclosed by a first power-transmitting coil enclosure sheet formed in a cylindrical shape and having higher conductivity than the elongated object main body.

13. The power feeding device according to claim 9, wherein
the first power-receiving coil enclosure sheet and the first power-transmitting coil enclosure sheet are made of a copper-based metal or an aluminum-based metal.

14. The power feeding device according to claim 10, wherein
the first power-receiving coil enclosure sheet and the first power-transmitting coil enclosure sheet are made of a copper-based metal or an aluminum-based metal.

15. The power feeding device according to claim 9, wherein
a second power-receiving coil enclosure sheet constituted by a cylindrical magnetic body is provided between the power-receiving coil and the first power-receiving coil enclosure sheet, and
a second power-transmitting coil enclosure sheet constituted by a cylindrical magnetic body is provided between the power-transmitting coil and the first power-transmitting coil enclosure sheet.

16. The power feeding device according to claim 10, wherein
a second power-receiving coil enclosure sheet constituted by a cylindrical magnetic body is provided between the power-receiving coil and the first power-receiving coil enclosure sheet, and
a second power-transmitting coil enclosure sheet constituted by a cylindrical magnetic body is provided between the power-transmitting coil and the first power-transmitting coil enclosure sheet.

17. The power feeding device according to claim 15, wherein
the second power-receiving coil enclosure sheet and the second power-transmitting coil enclosure sheet are made of ferrite.

18. The power feeding device according to claim 16, wherein
the second power-receiving coil enclosure sheet and the second power-transmitting coil enclosure sheet are made of ferrite.

19. The power feeding device according to claim 1, wherein
the power feed line is a shielded cable.

20. The power feeding device according to claim 2, wherein
the power feed line is a shielded cable.
